(19) United States
(12) Patent Application Publication
(10) Pub. No.: US 2025/0148039 A1
(43) Pub. Date: May 8, 2025

(54) GENERIC WEB PAGE EXTRACTION AND DATA COMPARISON FRAMEWORK

(71) Applicant: SAP SE, Walldorf (DE)

(72) Inventor: Ashish Kumar, Patna (IN)

(73) Assignee: SAP SE, Walldorf (DE)

(21) Appl. No.: 18/386,339

(22) Filed: Nov. 2, 2023

(51) Int. Cl. G06F 16/958; G06F 40/18

(52) U.S. Cl. CPC G06F 16/986; G06F 40/18

(57) ABSTRACT

The present disclosure provides techniques and solutions for comparing source data with data extracted from a source. A user provides an identifier of a web page and an identifier of a file having data exported from the web page. Data for a table of a web application is extracted from web application code by analyzing the web application code for a table identifier token. The extracted data is compared with data exported from the web application to the file. Differences between the extracted data and the data exported from the web application to the file are determined. The differences are presented to a user on a user interface display.

### FIELD

The present disclosure generally relates to data extraction and comparison.

### BACKGROUND

Often it is desirable to transfer data between software programs, whether a program executes locally or in a network environment, such as a cloud-based software application. As a particular example, it may be desired to take data that is in a tabular form, or an equivalent format, from a software application, which may be a more general-purpose software application, to a more specialized program, such as a spreadsheet program.

The transfer of such information can be desired for a variety of reasons. For example, a user may wish to transfer data to a software program they are more familiar with, so they can more easily analyze and manipulate the data, such as a spreadsheet program. They may also wish to export data from an application so that they have a local copy available. Exporting data can also provide a “snapshot” of data at a particular time, which can be useful when data may be updated periodically. In terms of data manipulation, exporting data can be beneficial as it can allow a user to make changes or additions to data for simulation purposes, without affecting data that might be used in a production setting or be accessible by other users.

However, issues can arise when exporting data. For example, differences in character encodings can cause values to change between the data as represented in an application and the data as represented in a spreadsheet after export. The application and spreadsheet may also be set to recognize and process data in different ways. For example, a spreadsheet may assume numbers having particular characteristics correspond to dates, and format them as such, when in fact the application data does not represent a date. Differences in character encoding can cause data misinterpretation, and different data representations can cause values to be split or merged when represented in a spreadsheet file, including when application data include hierarchical structures/nesting. Rounding or other types of mathematical operations can also give rise to differences between application data and corresponding data in a spreadsheet file.

Other issues that can arise when data is transferred between applications include incomplete data transfer, such as if data transmission is interrupted or memory buffers become full. Or, data differences can arise from incomplete loading of dynamic application data. Differences can also arise from filters applied to the application data. In some cases, where application data is the result of processing by an equation, the unprocessed values may be sent, or even the equation, rather than sending the processed values.

Serious issues can arise if spreadsheet data is relied upon but does not accurately reflect source application data. Manually confirming that source data and exported data can be tedious, time consuming and error prone. Often, application data can have significant numbers of attributes (such as represented in columns) and rows, and it may not be practically feasible to review data manually. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for comparing source data with data extracted from a source. A user provides an identifier of a web page and an identifier of a file having data exported from the web page. Data for a table of a web application is extracted from web application code by analyzing the web application code for a table identifier token. The extracted data is compared with data exported from the web application to the file. Differences between the extracted data and the data exported from the web application to the file are determined. The differences are presented to a user on a user interface display.

In a particular aspect, the present disclosure provides a process of comparing file data, such as data in a spreadsheet file, with data extracted from a web page, source as from code of a web page. An identifier of a spreadsheet file is received. An identifier of a web page that includes table data is received. The web page includes an identifier of the table.

Code of the web page is analyzed. A table identifier token is identified in the code of the web page, based on the analyzing.

Table data is extracted from code of the web page for a table associated with the table identifier token, providing extracted table data. The extracted table data is compared with data of the spreadsheet file. Based on the comparing, one or more differences between the extracted table data and the spreadsheet data are identified to provide one or more identified differences. The one or more identified differences are stored, and are displayed to a user on a user interface.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram of a computing environment in which disclosed techniques can be implemented, where a comparison framework can access data in a web application and a file of a target system.

FIG. 2 is a diagram illustrating a web page with tabular data and associated code for the web page.

FIG. 3 is flowchart of an example process for comparing file and web page data.

FIG. 4 is an example user interface screen illustrating how information about a file and a web page to be compared can be provided, along with user credentials for accessing the web page.

FIG. 5 illustrates how differences between file data and web page data can be presented.

FIGS. 6A and 6B provide example HTML code having a table identifier than can be used as part of a data extraction process.

FIGS. 6C-6E illustrate an example document object model for the HTML code of FIGS. 6A and 6B.

FIG. 7 illustrates an example JSON structure that can be used to store table data.

FIG. 8 is a flowchart of a process for comparing web page data with spreadsheet data.

FIGS. 9A-9C provide example client-side code for disclosed techniques.

FIGS. 10A-10E provide example server-side code for disclosed techniques.

FIG. 11 is a flowchart of a process of comparing file data with extracted web page data.

FIG. 12 is a diagram of an example computing system in which some described embodiments can be implemented.

FIG. 13 is an example cloud computing environment that can be used in conjunction with the technologies described herein.

### DETAILED DESCRIPTION

### Example 1

### Overview

Often it is desirable to transfer data between software programs, whether a program executes locally or in a network environment, such as a cloud-based software application. As a particular example, it may be desired to take data that is in a tabular form, or an equivalent format, from a software application, which may be a more general-purpose software application, to a more specialized program, such as a spreadsheet program.

The transfer of such information can be desired for a variety of reasons. For example, a user may wish to transfer data to a software program they are more familiar with, so they can more easily analyze and manipulate the data, such as a spreadsheet program. They may also wish to export data from an application so that they have a local copy available. Exporting data can also provide a “snapshot” of data at a particular time, which can be useful when data may be updated periodically. In terms of data manipulation, exporting data can be beneficial as it can allow a user to make changes or additions to data for simulation purposes, without affecting data that might be used in a production setting or be accessible by other users.

However, issues can arise when exporting data. For example, differences in character encodings can cause values to change between the data as represented in an application and the data as represented in a spreadsheet after export. The application and spreadsheet may also be set to recognize and process data in different ways. For example, a spreadsheet may assume numbers having particular characteristics correspond to dates, and format them as such, when in fact the application data does not represent a date. Differences in character encoding can cause data misinterpretation, and different data representations can cause values to be split or merged when represented in a spreadsheet file, including when application data include hierarchical structures/nesting. Rounding or other types of mathematical operations can also give rise to differences between application data and corresponding data in a spreadsheet file.

Other issues that can arise when data is transferred between applications include incomplete data transfer, such as if data transmission is interrupted or memory buffers become full. Or, data differences can arise from incomplete loading of dynamic application data. Differences can also arise from filters applied to the application data. In some cases, where application data is the result of processing by an equation, the unprocessed values may be sent, or even the equation, rather than sending the processed values.

Serious issues can arise if spreadsheet data is relied upon but does not accurately reflect source application data. Manually confirming that source data and exported data can be tedious, time consuming and error prone. Often, application data can have significant numbers of attributes (such as represented in columns) and rows, and it may not be practically feasible to review data manually. Accordingly, room for improvement exists.

The present disclosure provides techniques that provide for application-agnostic data comparison. The present disclosure describes these techniques as comparing data from an application, such as a cloud-based application, and more particularly a web-based application, with data maintained in a spreadsheet program, such as MICROSOFT EXCEL.

More particularly, the techniques can be used, without limitation, with EXCEL export functionality provided by FIORI applications of SAP SE. For example, application data can be exported from a FIORI application using an export command provided by the application. A user, or computing process, can then select to compare the exported data with the data maintained by the application. In a specific technique, a user can provide a URL for a relevant web-based software application and a spreadsheet file, and optionally access credentials (such as a username/password) for the software application, and initiate a comparison. The disclosed techniques can be used in an analogous manner with other types of web-based applications.

Comparison results can indicate whether the data in the spreadsheet file is consistent with data in the web application. The comparison results can be provided at different levels of granularity, whether in the same use scenario or in different use scenarios. In some cases, a result can be whether the data is consistent or not. A result can also indicate a general type of inconsistency, such as whether the spreadsheet has added data or missing data compared with the web application, or whether values differ between the spreadsheet and the software application. At a more granular level, specific rows, column, or cells of the spreadsheet file can be indicated as having added, missing, or inconsistent data. In yet another scenario, a result can indicate specific cells that have missing, added, or different values, and a value of the web application can be provided in connection with the cell so a user may compare the differences between the spreadsheet data and the web application.

While the comparison can be made with respect to the spreadsheet data, it can also be made with respect to the web application data. That is, for example, data for the web application can be provided with indications of added, missing, or different values, and optionally with corresponding values of the spreadsheet data.

As described above, various types of differences between the spreadsheet data and the web application data can exist. If desired, a program that makes or requests a comparison can limit the type of differences that will be reported. For example, date data that is different formats may not be flagged as a data discrepancy. Similarly, numbers that have been rounded or are otherwise reported with higher or lower precision can be specified as not corresponding to a data discrepancy. A tolerance level can be specified, and two values will not be reported as different if their absolute difference is lower than the tolerance level. Similarly, strings may be set to have different lengths, and string values may be considered the same if the values are the same to the extent the two strings overlap in length.

Various techniques can be used to provide “generic” comparison functionality. For example, a standard computing language, such as HTML, can include features, such as tags, to indicate tables or table rows. Code of a web page having application data can be parsed to identify a table and to extract table data. Thus, disclosed techniques can be used with any web-based application or data source that uses standard tags. Similarly, a document model object (DOM) generated from the HTML can be parsed and data extracted from the DOM, either using the appropriate tag or using an identifier defined in the HTML (for example, looking for the <table> tag and then extracting the identifier assigned to that table).

Accessing and extracting data can be automated using an automation tool, such as SELENIUM (Software Freedom Conservancy). That is, an automation script can be written to access a web page at a specified URL, identify a table in the webpage, and extract data from the web page.

In some cases, extracted web page data can be directly compared with spreadsheet data. In other cases, it can be useful to extract spreadsheet data for comparison. For example, both the web page data and the spreadsheet data can be stored in a common JSON or HTML format.

The disclosed techniques thus provide a variety of benefits. Comparisons can be automated, which can enable comparisons that could not practically be made manually, which can be performed more quickly, and are less prone to error. In addition, disclosed techniques reduce coding burden because data extraction and comparison logic does not need to be written on an application-by-application basis. Disclosed techniques are implemented in a specific, technological way, including in a way that would not be performed manually by humans. For example, humans would not need to extract data from a web application or from a spreadsheet file in order to compare two sets of data.

### Example 2

### Example Comparison Computing Environment

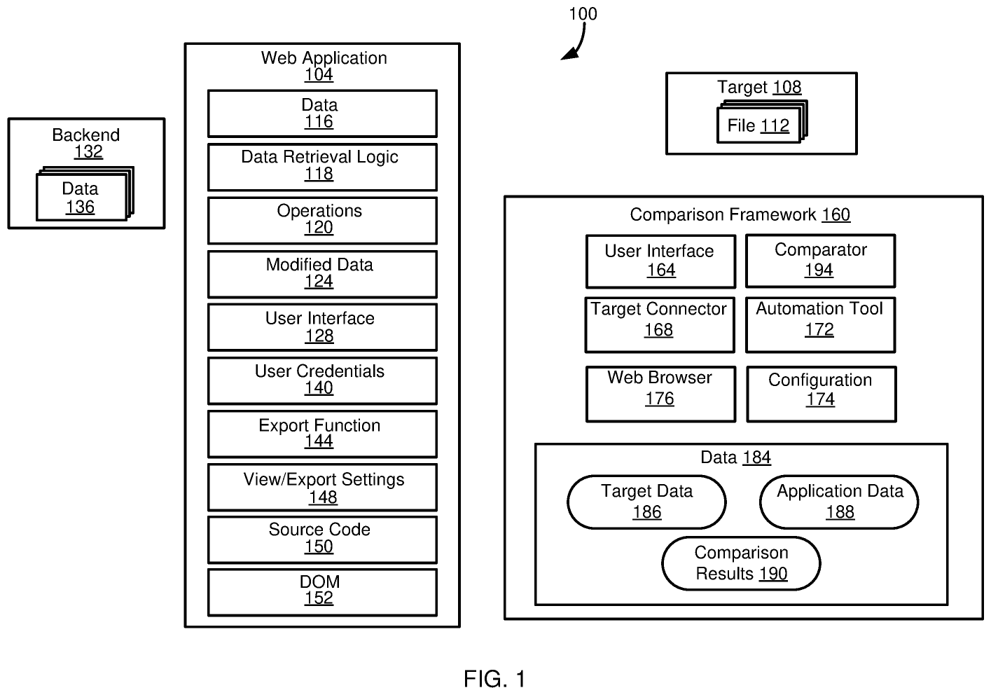

FIG. 1 illustrates an example computing environment 100 in which disclosed techniques can be implemented. The computing environment 100 includes a web application 104 and a target 108, such as a target system or application. For example, the target 108 can be a target system that includes one or more files 112, such as spreadsheet files. The files 112 can be in different formats. For example, a file 112 can be a native/primary format used by a spreadsheet software application (*.xls, *xlsx). Or, a file 112 can be in a format that a spreadsheet program supports as an export format, such as comma separated values, JSON, or HTML.

The web application 104 can be in the form of a particular web page. The web application 104 can include data 116 or data retrieval logic 118. For example, the web application 104 can include static data 116 or can include data retrieved dynamically using the data retrieval logic 118, such as data retrieved when a web page is loaded. Combinations of stored data 116 and dynamically retrieved data are also possible. In one scenario, a most recently used set of dynamically retrieved data 116 is saved or is otherwise available when the web application is 104 is accessed again.

The web application 104 can perform operations 120 on the data 116, particularly for data retrieved dynamically, to produced modified data 124. The modified data 124 can be displayed on a user interface 128 of the web application 104, in addition to, or in place of, the data 116. The operations 120 can include operations such as filtering, aggregation, ordering, grouping, or rounding.

In some cases, data 116 retrieved using the data retrieval logic 118 can be specific to a particular user or a particular type of user. For example, different users can have their own sets of data 136 stored on a backend system 132, such as in relational database tables. Or, an employee of one type may have access to different types of data 116, including as associated with the data 136. The web application 104 can use user credentials 140 in various ways, such as to determine if a user is authorized to access a particular web application, as well as to determine what data 116, or modified data 124, to present to the user.

Note that disclosed techniques can be advantageous in retrieving data from the web application 104 as opposed to from the backend system 132. For example, the data 116 or the modified data 124 may more closely correspond to data in a file 112. If the data in the file 112 corresponds to modified data 124, data 136 from the backend system 132 may not correspond to the modified data since it was not processed using the operations 120. Similarly, data in a file 112 may represent data exported from the web application 104 using an export function 144, where the export function applies view or export settings 148. That is, for example, a user may have chosen to filter data in the web application 104 through the user interface 128, and retrieving data from the web application 104 can cause these filters to be applied while extracting data from the web application, whereas these filters would not be available for the data 136.

The computing environment 100 further includes a comparison framework 160. While shown as a separate component, the comparison framework 160 can be included as part of a web application 104 or as part of the target 108. The comparison framework 160 can be incorporated into a standalone software application, or can be incorporated into other software applications.

The comparison framework 160 includes a user interface 164. The user interface 164 allows a user to specify a particular web application 104 and a particular file 112 to be compared. The file 112 can be retrieved by a target connector 168, such as uploading a file from a destination represented by the target 108.

The comparison framework 160 can be part of a software application running remotely. The user can interface with the user interface 164 remotely, and can upload a file 112 to be sent to the remote software application (that is, one having the comparison framework 160) and used in a comparison. The user can specify a web application 104 using the user interface, such as providing a URL. The user can also provide any needed credentials for accessing the web application 104, either for security reasons or to help ensure that appropriate (user-specific) data is retrieved.

A URL provided by the user can be accessed by an automation tool 172, such as SELENIUM. An automation tool 172 can perform scripted actions with respect to web pages, such as web pages associated with a web application 104. As will be further described, an automation tool 172 can access a web page, parse code for the web page to identify table structures, and extract data from the table structures, such as using a web browser 176. The automation tool 172 can also perform actions such as formatting extracted data, including in a manner that can facilitate data comparison with data from a file 112. In a particular example, the automation tool 172, or another component of the comparison framework 160, formats extracted data into a JSON structure having a format/schema, and such data can be compared with data from a file 112 that is in the same JSON format/schema.

The automation tool 172 can access automation configuration information 174. The automation configuration information 174 can include scripts that are executed by the automation tool 172. The automation configuration 174 can include scripts based on particular types of code used in the web application 104. For example, a script can be prepared to identify tables based on parsing the source code of a web page for the <table> tag. Web applications 104 can be defined using other types of coding or frameworks, including SAP FIORI or UI5. In that case, tables can be identified by the term “MTable,” and content for table rows identified using the “li” tag. Scripts can be defined to look for a variety of data identifiers, or specific scripts can be developed for specific programming models. In some cases, a URL can be parsed to identify what type of script should be used for a particular web application 104 (such as if the URL indicates a Fiori application or other particular web application format).

As will be further described, in extracting information from the web application 104, the automation tool 172 can examine code of a web page, such as source code 150 or a document object model (DOM) 152 generated from the source code.

The automation tool 172 can be operated in a “headless mode,” where web pages, such as for a web application 104, are accessed without displaying a graphical user interface of the web browser 176. Since the web browser 176 is not displayed, extracting data from web pages can be more computationally efficient, including reducing computing resource use and providing faster execution. In addition, this can make automated techniques of the present disclosure more computationally efficient than manual user inspection of web pages, which would require the generation of user interface displays on a launched web browser 176.

The comparison framework 160 can store various types of data 184. For example, the comparison framework 160 can store data 186 from a file 112, extracted web application data 188, and comparison results 190.

The comparison results 190 can be generated by a comparator 194. The comparator 194 identifies data in the file data 186 and looks for corresponding data in the web application data 188, or identifies data in the application data and looks for corresponding data in the file data. The results can be stored as the comparison results 190, which can be rendered for display using the user interface 164. As described, the comparator 194 can seek to identify data that is missing from, or added to, one data set compared with the other, or data values that are expected to be the same, but which have different values.

### Example 3

### Example Web Page and Associated Code with Tokens Useable for Table Identification and Data Extraction

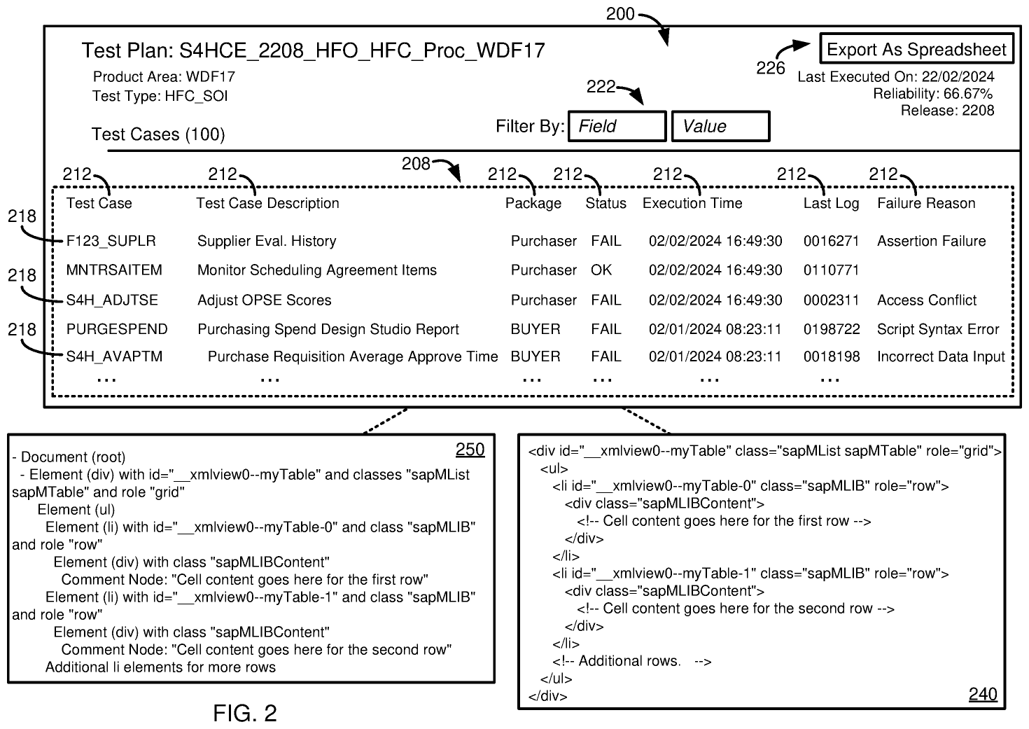

FIG. 2 illustrates an example user interface 200 of a web application, such as a particular web page, along with a portion of source code associated with the user interface, shown as source code 240 and a document object model (DOM) 250. It can be seen that the user interface 200 displays data in a table 208, including in columns 212, having headers or labels, and in rows 218.

The user interface 200 can include a control 222 to allow a user to filter values displayed in the table. The user interface 200 can also include a control 226 that exports data in table 208 into a spreadsheet file/format. The exported data can be data subject to the filer. The user may also be provided with options after selecting the export data control 226, such as to export all data, data after the application of a filter defined using the control 222, or filter values define as part of the export process. That is, selecting the export data control 226 can cause a menu to be presented that allows for filters to be specified for data export, or to use or not use filters applied using the control 222.

As described, disclosed techniques can be advantageous as they can allow data to be extracted from a web application, or any web page, using source code for the web page or a document object model produced from the source code, including based on interactions with an initial document object model produced from the source code during an initial page load. Web browsers typically provide functionality for viewing source code or a DOM for a web page, and such functions can be used by an automation tool in extracting data from the user interface 200 (which, as discussed, is not required to be displayed during extraction, such as when an automation tool operates in a headless mode).

FIG. 2 provides an HTML representation 240 of a portion of source code used to generate the user interface 200, and more particularly the table 208, and a corresponding DOM representation 250. For the HTML representation 240, the table 208 can be identified using the “sapMTable” tag, and the “li” tags can be used to identify data for particular table rows 218. Similarly, the DOM representation 250 includes the “sapMTable” and “li” tags.

Note that the HTML representation 240 would typically be used for “static” data for a web page. The DOM representation 250 can be used to access static data, as well as data dynamically retrieved during use of the webpage. The DOM representation 250 can be specific to a particular user, and so access credentials can be used to retrieve a specific DOM 250 saved for a specific user, or a DOM representation based on a “default” setting, such as a fresh data load performed when a page is accessed or refreshed.

### Example 4

### Example Process of Extracting and Comparing Web Page Data with File Data

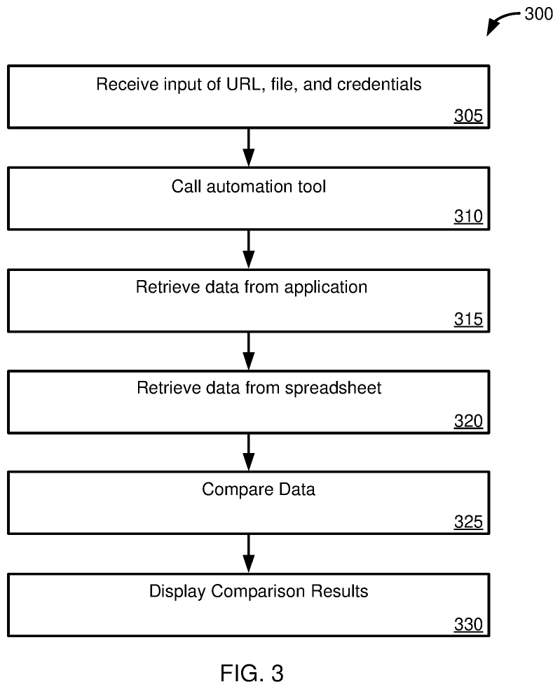

FIG. 3 illustrates a flowchart of a process 300 according to the present disclosure. At 305, input is received, such as from a user. The input can include a URL of a web page (such as for a web application), a file (such as by attaching a file or providing a file path where a file can be accessed), and optionally user credentials, such as a username and password.

An automation tool is called at 310. The automation tool is provided with at least the URL and any access credentials. The automation tool retrieves data from the web page at 315. Retrieving data from the web page can include launching a web browser in a headless mode. The web page is accessed using the URL, and access credentials can be input to the web page in appropriate scenarios.

Retrieving the data at 315 can include parsing source code for the web page, or a DOM for the web page. In particular the parsing can include identifying tokens that indicate the presence of a table, and particular data elements, such as rows, of the table. Parsing the source code or DOM can include recognizing an identifier for the table, where the identifier can be used in data extraction, such as in programmatic operations to extract operations from a DOM. The use of an identifier for extraction can provide for more accurate results, such as if web page source code or a DOM representation includes multiple tables.

Data is retrieved from the file, such as a spreadsheet file, at 320. Retrieving data from the file can use the file in a “native” format, or can include exporting or converting the data to another format. For example, retrieving the data at 315 can include storing the data in a particular format (e.g., JSON), which can have a particular structure, and retrieving data from the spreadsheet at 320 can include converting the spreadsheet data to the same format and structure.

The file data and the application data are compared at 325. The comparison can be made in a variety of ways depending on a desired implementation, such as comparing data on a table-by-table, row-by-row, column-by-column, or cell-by-cell basis. If only a general indication of whether two tables are the same is desired, hash values can be generated for the file data and the application data and compared, where a difference in hash values can indicate a data inconsistency.

Comparison results are provided at 330. As will be described, comparison results can be provided at different levels of granularity, including indicating simply whether data is consistent or not, indicating specific data elements (cells, columns, rows) having an inconsistency, indicating a type of inconsistency, or providing details regarding an inconsistency, such as providing a value from the spreadsheet and what should be a corresponding value from the application data.

### Example 5

### Example User Interface for Providing Comparison Process Parameters

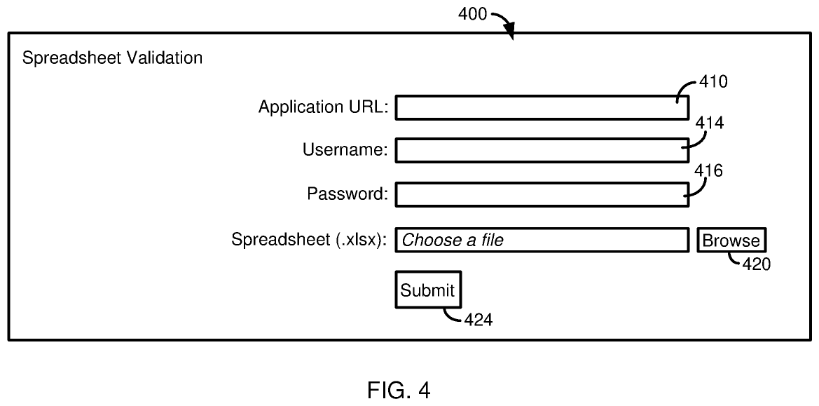

FIG. 4 illustrates an example user interface 400 that can be used to initiate a data comparison process. The user interface 400 includes a field 410 to provide an URL for a particular web application from which data is to be extracted and compared. Fields 414, 416 allow a user to enter access credentials, such as a username and password. User interface control 420 can be used to select a file to be used in the comparison. The selected file can be processed locally, or can be uploaded to another computing system for processing. The comparison process can be initiated by selecting user interface control 424.

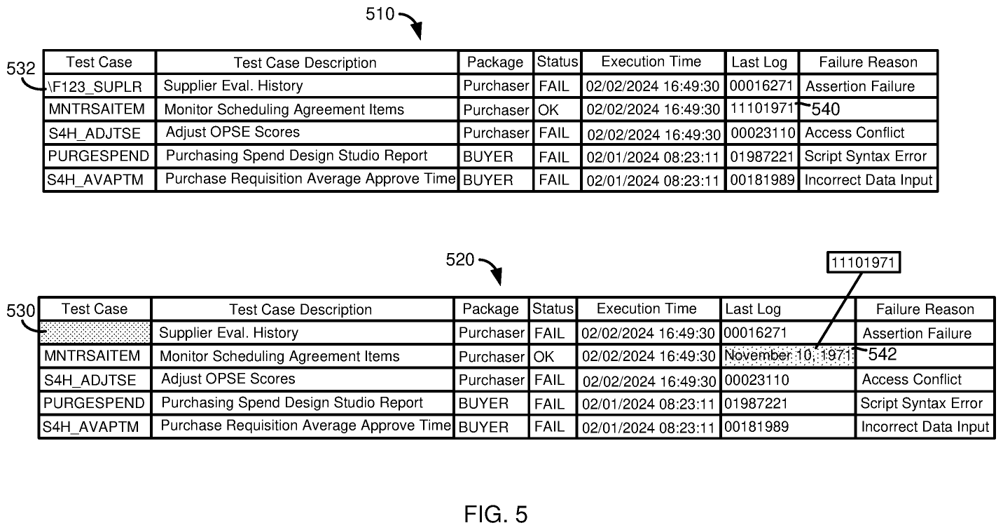

FIG. 5 illustrates examples of how comparison results can be presented to a user. FIG. 5 illustrates a first set of data 510, which can represent data as maintained in a web application. FIG. 5 also illustrates a second set of data 520, which can represent data as maintained in a spreadsheet file. In one example, different colors or other visual cues (in this case, fill patterns) can be used to indicate data discrepancies to a user. Different cues can be used to identify missing data, added data, or data having mismatched values. As shown, cell 530 of the second set of data 520 is missing a value as compared with a corresponding cell 532 of the first set of data 510. The cell 530 has a first fill pattern, which can be used to indicate missing values.

The second set of data 520 further includes a cell 542 that has a value that is different than a corresponding cell 540 of the first set of data 510. That the cell 542 has different data can be indicated using a second fill pattern. In this case, it can be seen that the data mismatch between the cell 540 and the cell 542 is that an export process to a spreadsheet file caused a value in the cell 540 to be interpreted as a date, which was then converted into a date format in the second set of data.

As discussed, a user can optionally be provided with additional information. For example, by hovering a cursor over the cell 542, the value of the cell 540 is displayed.

The comparison results in FIG. 5 are provided by way of example only. Other types of comparison results can be provided, including a simple indication of whether the spreadsheet data is consistent with the application data. Alternatively, rather than providing the second set of data 520 to be rendered with the visual information, a textual summary of differences can be provided. Or, rather than highlighting a single cell with an inconsistent value, an entire row or entire column of data associated with the inconsistent value can be highlighted. In addition, rather than showing differences relative to the spreadsheet data, as in FIG. 5, differences can be shown (or textually described) relative to the application data (e.g., showing the application data with information indicating cells or other table elements that differ from the spreadsheet data).

### Example 6

### Example Web Page Code with Table Identifier Token

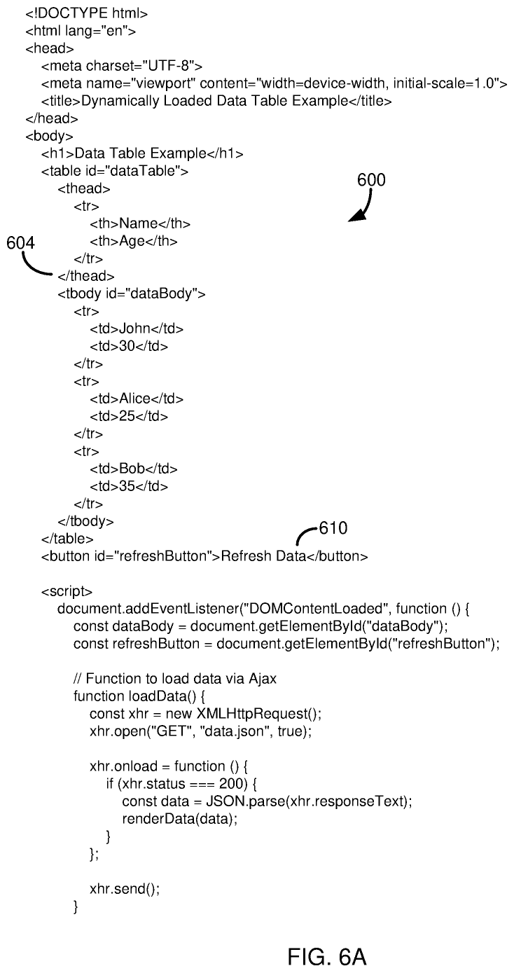

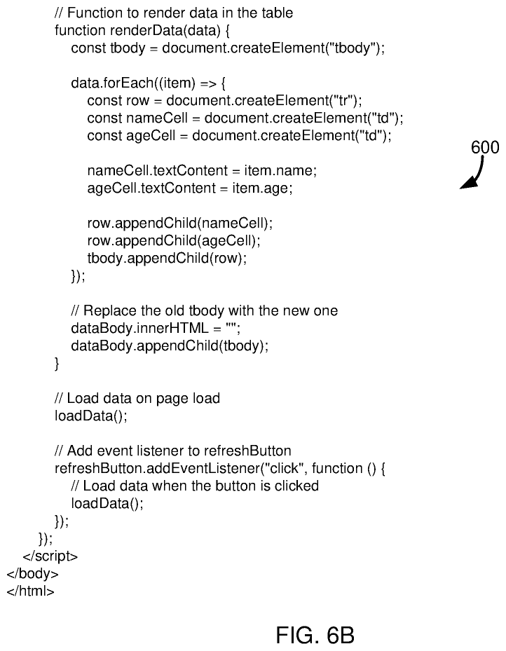

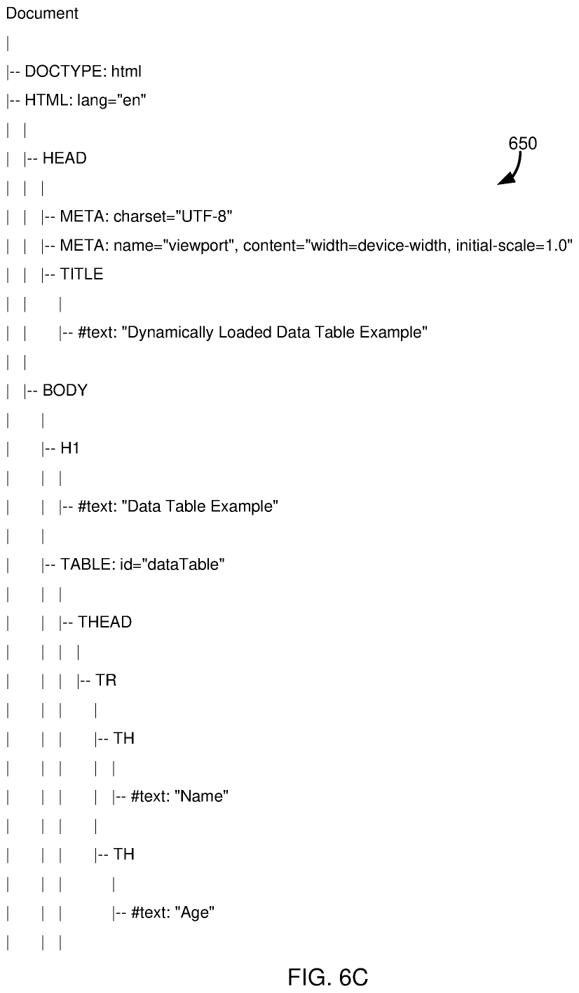

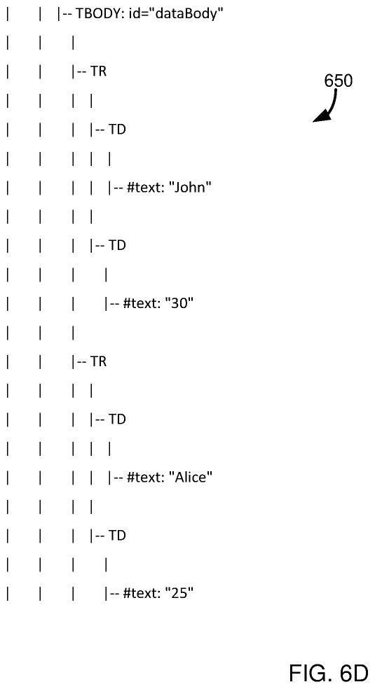

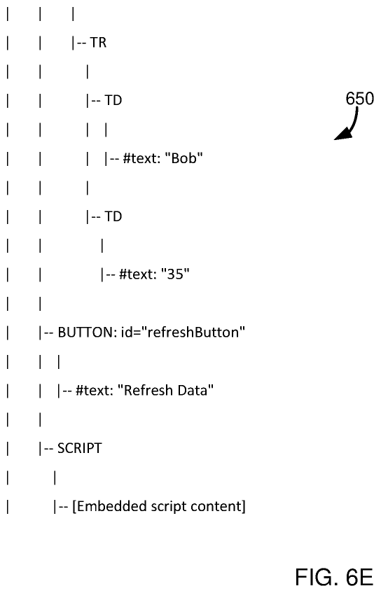

FIGS. 6A and 6B contain example HTML code 600. The HTML code 600 include “static” tabular data that can be identified in the HTML code and extracted for comparison purposes. For example, the HTML code 600 can be parsed to identify the “table” tag 604. Once the section of the HTML code 600 having the table tag 604 is identified, that section can be further parsed to identify column headings, having the “th” tag. Values for the columns, such as data in table rows, can be identified and extracted by locating the “tr” tags. Alternatively, this initial data could be identified by searching for the table tag and corresponding tags in a DOM produced from the HTML code 600.

The code 600 defines a user interface control, in the form of a button 610. When the button is selected, data associated with the table in the HTML code 600 is dynamically refreshed, which updates the DOM, but not the HTML code itself. Parsing the DOM after the refresh would result in extraction of the updated data, rather than the initial data specified in the HTML code. Conversely, parsing the HTML code 600 at any point would retrieve only the hardcoded original data.

FIGS. 6C-6E illustrates a simplified example DOM 650 that can be produced from the HTML code 600. The DOM 650 can be parsed in a similar manner as the HTML code 600, and as described with respect to FIG. 2. The DOM 650 shows initial data from the HTML code 600. As described, this data would be updated if the refresh button 610 were selected.

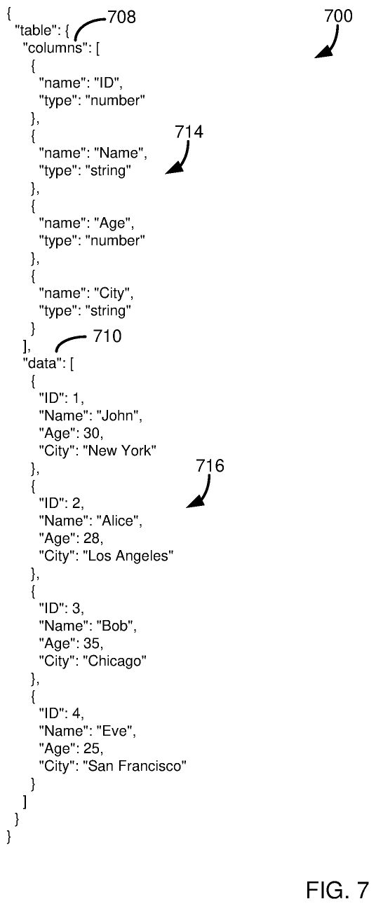

As discussed, data from a web page or from a spreadsheet can be stored in various formats, which can differ from a format in which the data was originally stored, and which can facilitate data comparison. FIG. 7 illustrates an example JSON object 700 that includes the table data defined in the HTML code 600. It can be seen that the JSON object 700 has objects 708, 710 for “columns” and “data”, where those objects are in turn associated with nested objects 714 including column header labels and data types, and objects 716 representing particular rows, having values for the columns declared in the objects 714.

### Example 7

### Example Process of Comparing Web Page Data with File Data

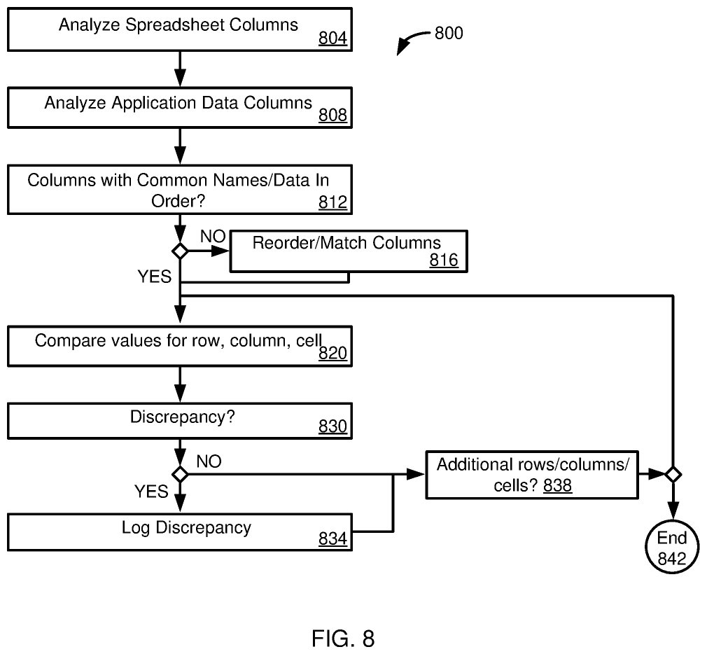

FIG. 8 provides a flowchart of a process 800 for performing a comparison between spreadsheet data and web page data. Spreadsheet data columns are analyzed at 804 and application data columns are analyzed at 808. Analyzing the data columns can include identifying a name/label or a datatype. It is determined at 812 whether the spreadsheet data columns and the application data columns are in a common order. For example, both the spreadsheet data and the application data can have columns A, B, and C, but the columns may appear in different orders, such as ABC versus BAC.

Determining whether data columns are in a common order can also include determining whether the spreadsheet data and the application data have the same number of columns. In some cases, having a different number of columns can indicate an export error, such as if some columns of application data were not exported to a spreadsheet. However, missing columns can also result from filter criteria used in an export. The process 800 can be configured to flag missing columns as export errors, or can assume that missing columns result from the export criteria and the missing columns can be omitted from a comparison process.

Determining whether data columns are out of order between the spreadsheet data and the application data can include analyzing the column names. Column datatypes and column data can also be used for this purpose, particularly if the application data or the spreadsheet data did not include column names (such as if “source” application data did not include column headers/attribute names). Columns having a common datatype can be used to suggest matching columns, particularly if there are only single columns in the application data and the spreadsheet data have the datatype. All or a portion of values in columns can be compared, such as indicating that two columns match if they share a threshold number of values. Values for multiple columns can also be used for this purpose-such as to help ensure that rows between the application data and the spreadsheet data also correspond.

If columns are out of order, or have different columns names, they can be reordered or matched at 816. If the columns are already matched and in order at 812, or after the operations at 816, the process 800 can start to compare values between the application data and the spreadsheet data at 820. Values can be compared in a variety of ways, such as by row, by column, or by cell.

It is determined at 830 whether the compared data matches. If not, the discrepancy can be logged at 834. Logging the discrepancy can include identifying a particular row, column, or cell where the discrepancy was noted, and including an expected value and an actual observed value. After the discrepancy is logged at 834, or determining that the data matches at 830, the process 800 proceeds to 838 where it is determined whether additional rows/columns/cells remain to be processed. If so, the process 800 can return to 820. If all data has been processed, the process 800 can end at 842.

### Example 8

### Example Client-Side Code and Server-Side Code

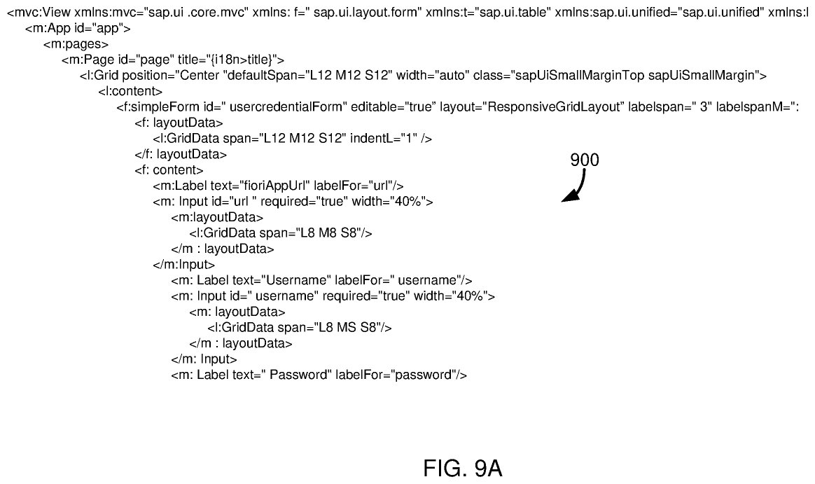

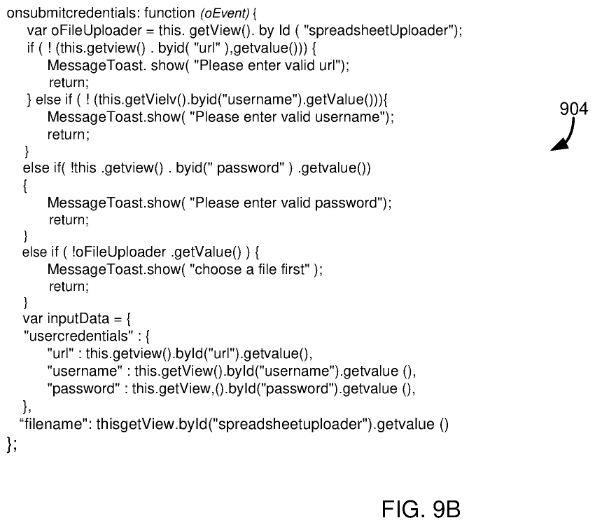

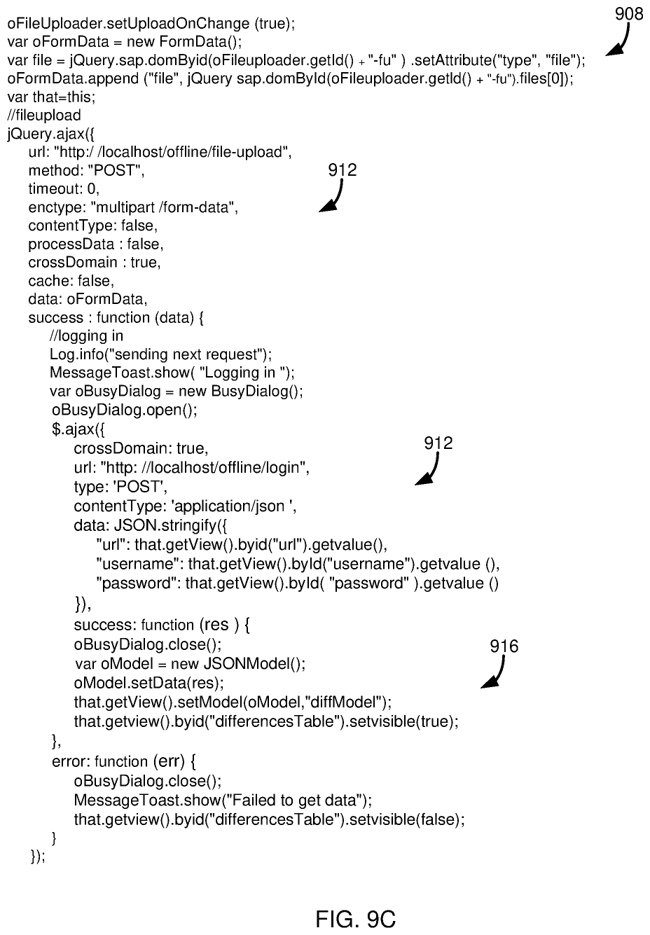

FIGS. 9A-9C illustrate example client-side code that can be used in implementing disclosure techniques. FIG. 9A provides example code 900 for a user interface that accepts user input for a comparison process, such as for generating the user interface 400 of FIG. 4. Code 904 of FIG. 9B checks for valid user input prior to initiating a comparison process. Code 908 of FIG. 9C uploads an indicated spreadsheet file. Code 912 of FIG. 9C uploads a web page and authentication information for use in extracting application data. Code 916 of FIG. 9C retrieves comparison results generated by a server.

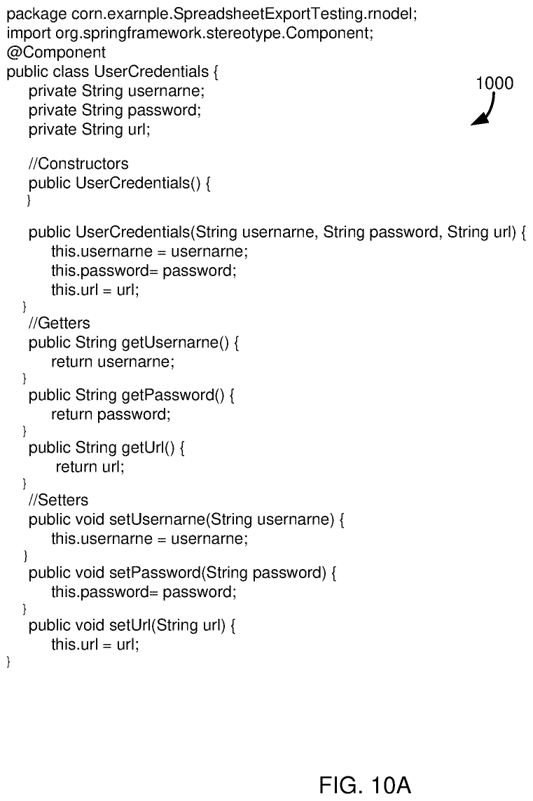

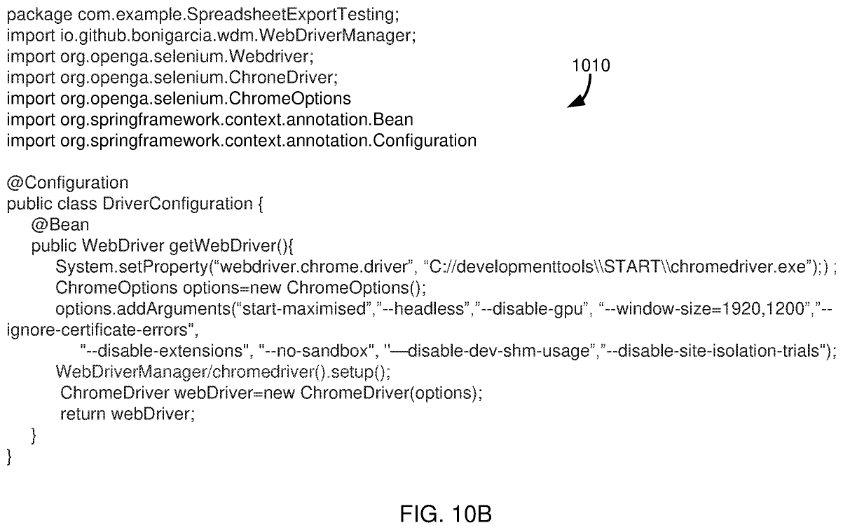

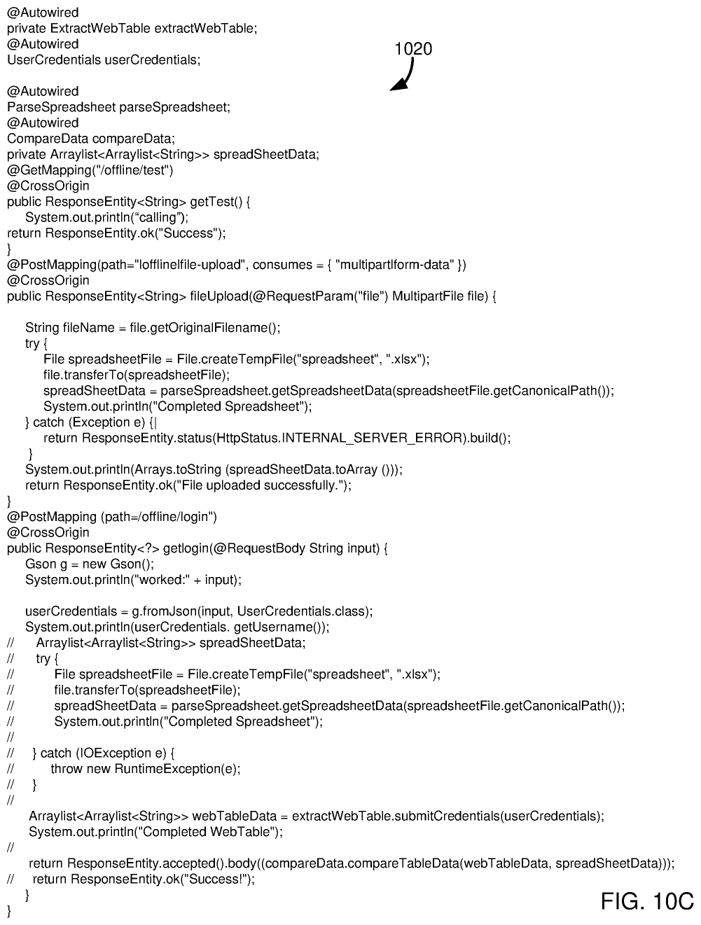

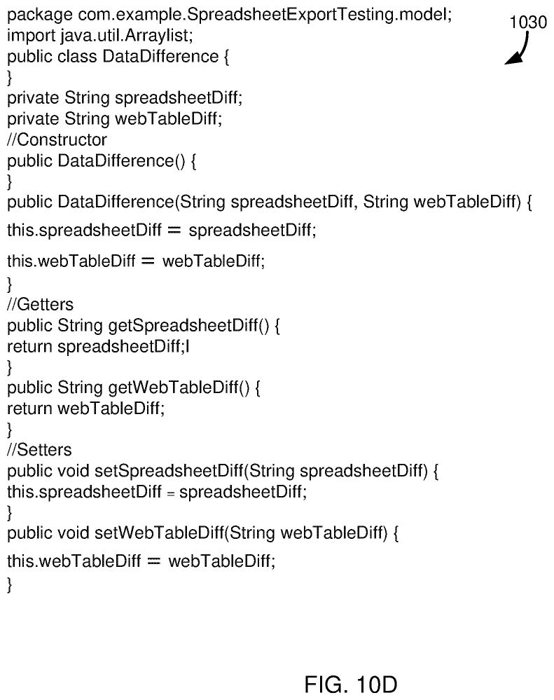

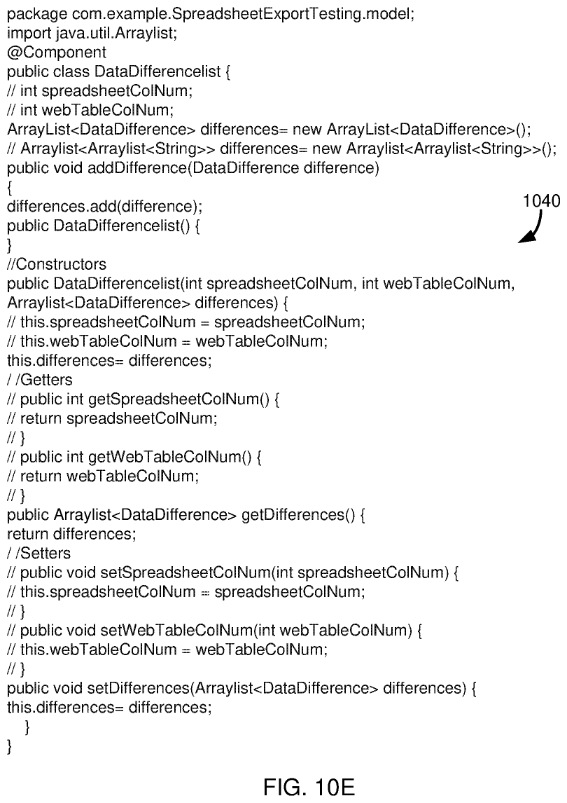

FIGS. 10A-10E illustrate example server-side code for use in disclosed techniques, including with the client-side code of FIGS. 9A-9C. Code 1000 of FIG. 10A creates a UserCredentials object using data sent from a client. Code 1010 of FIG. 10B instantiates a WebDriver object that can be used to automate data extraction from a web page, such as using the user credentials of the UserCredentials object of FIG. 10A.

Code 1020 of FIG. 10C extracts data from a provided spreadsheet file. Code 1020 of FIG. 10C also calls a method that uses SELENIUM function to extract web data using provided credentials.

Code 1030 of FIG. 10D takes strings of differences noted for a spreadsheet and for web application data and converts them to tabular representations. Code 1040 of FIG. 10E is used to create arrays of differences determined between spreadsheet data and web data.

### Example 9

### Example Process of Comparing File Data with Extracted Web Page Data

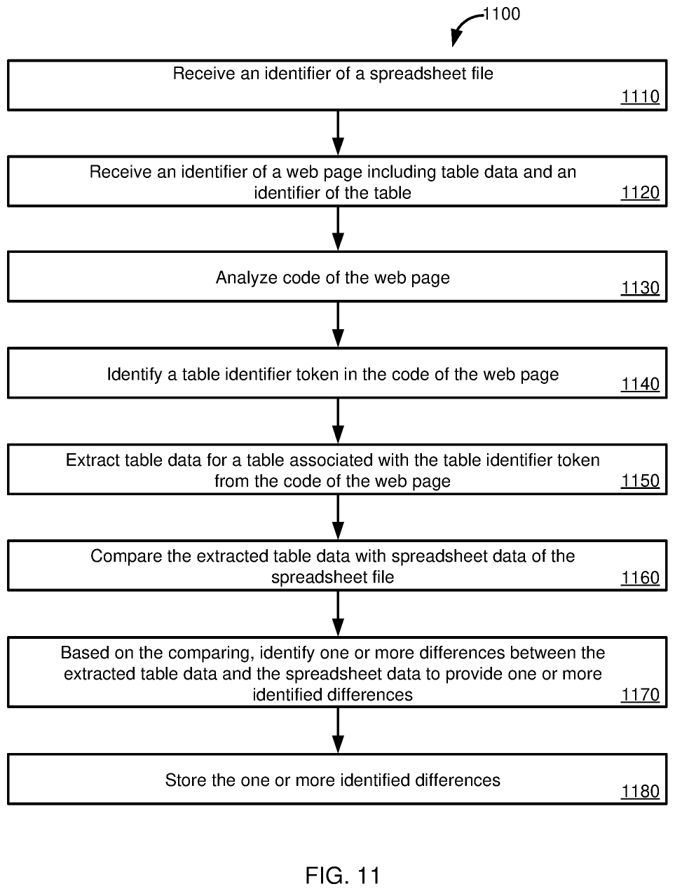

FIG. 11 is a flowchart of a process 1100 of comparing file data, such as data in a spreadsheet file, with data extracted from a web page, source as from code of a web page.

At 1110, an identifier of a spreadsheet file is received. An identifier of a web page that includes table data is received at 1120. The web page includes an identifier of the table.

At 1130, code of the web page is analyzed. A table identifier token is identified in the code of the web page at 1140, based on the analyzing.

Table data is extracted at 1150 from code of the web page for a table associated with the table identifier token, providing extracted table data. At 1160, the extracted table data is compared with data of the spreadsheet file. Based on the comparing, at 1170, one or more differences between the extracted table data and the spreadsheet data are identified to provide one or more identified differences. The one or more identified differences are stored at 1180, and are displayed to a user on a user interface.

### Example 10

### Computing Systems

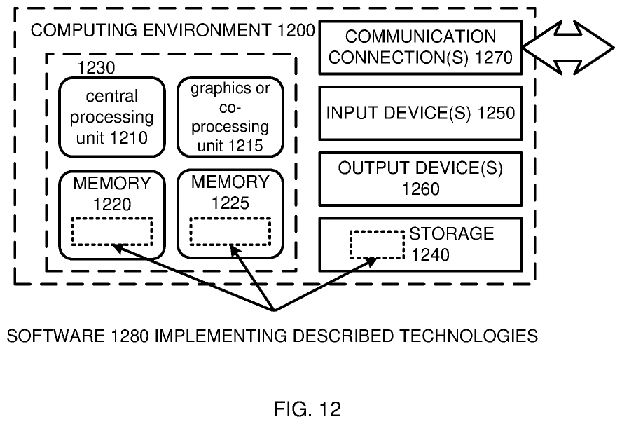

FIG. 12 depicts a generalized example of a suitable computing system 1200 in which the described innovations may be implemented. The computing system 1200 is not intended to suggest any limitation as to scope of use or functionality of the present disclosure, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions, such as for implementing a database environment, and associated methods, described in Examples 1-9. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s) 1210, 1215. The memory 1220, 1225 stores software 1280 implementing one or more innovations described herein, in the form of computer-executable instructions suitable for execution by the processing unit(s) 1210, 1215.

A computing system 1200 may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way, and which can be accessed within the computing system 1200. The storage 1240 stores instructions for the software 1280 implementing one or more innovations described herein.

The input device(s) 1250 may be a touch input device such as a keyboard, mouse, pen, or trackball, a voice input device, a scanning device, or another device that provides input to the computing system 1200. The output device(s) 1260 may be a display, printer, speaker, CD-writer, or another device that provides output from the computing system 1200.

The communication connection(s) 1270 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11

### Cloud Computing Environment

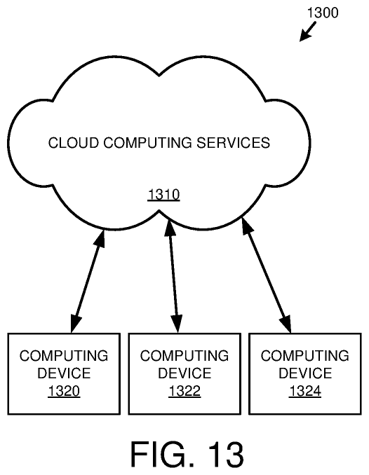

FIG. 13 depicts an example cloud computing environment 1300 in which the described technologies can be implemented. The cloud computing environment 1300 comprises cloud computing services 1310. The cloud computing services 1310 can comprise various types of cloud computing resources, such as computer servers, data storage repositories, networking resources, etc. The cloud computing services 1310 can be centrally located (e.g., provided by a data center of a business or organization) or distributed (e.g., provided by various computing resources located at different locations, such as different data centers and/or located in different cities or countries).

The cloud computing services 1310 are utilized by various types of computing devices (e.g., client computing devices), such as computing devices 1320, 1322, and 1324. For example, the computing devices (e.g., 1320, 1322, and 1324) can be computers (e.g., desktop or laptop computers), mobile devices (e.g., tablet computers or smart phones), or other types of computing devices. For example, the computing devices (e.g., 1320, 1322, and 1324) can utilize the cloud computing services 1310 to perform computing operators (e.g., data processing, data storage, and the like).

### Example 12

### Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 12, computer-readable storage media include memory 1220 and 1225, and storage 1240. The term computer-readable storage media does not include signals and carrier waves. In addition, the term computer-readable storage media does not include communication connections (e.g., 1270).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving an identifier of a spreadsheet file;
receiving an identifier of a web page comprising table data of a table, the web page comprising an identifier of the table;
analyzing code of the web page;
identifying a table identifier token for the table in the code of the web page based on the analyzing;
extracting table data for the table associated with the table identifier token from the code of the web page to provide extracted table data;
comparing the extracted table data with spreadsheet data of the spreadsheet file;
based on the comparing, identifying one or more differences between the extracted table data and the spreadsheet data to provide one or more identified differences; and
storing the one or more identified differences, wherein the one or more identified differences are displayed to a user on a user interface.

2. The computing system of claim 1, wherein analyzing the code of the web page comprises analyzing source code of the table.

3. The computing system of claim 1, wherein analyzing the code of the web page comprises analyzing a document object model for the web page.

4. The computing system of claim 1 wherein the table identifier token is a tag in the code of the web page.

5. The computing system of claim 1, wherein the table identifier token is an element of a document object model of the web page.

6. The computing system of claim 1, the operations further comprising:
receiving user credentials for the web page; and
prior to analyzing code of the web page, authenticating to the web page using the user credentials.

7. The computing system of claim 6, wherein the web page dynamically loads or updates data based at least in part on the user credentials, which serve as filter criteria for data inclusion in the code of the web page.

8. The computing system of claim 1, wherein extracting table data comprises extracting table data in a first format, the operations further comprising:
extracting at least a portion of the spreadsheet data in the first format;
wherein comparing the extracted table data with the spreadsheet data comprising comparing data in the first format.

9. The computing system of claim 1, the operations further comprising:
causing a display to be rendered that displays the one or more identified differences.

10. The computing system of claim 9, wherein for an identified difference of the one or more identified differences, the display displays a value of the extracted table data and a value of the spreadsheet data.

11. The computing system of claim 1, wherein the spreadsheet data and the extracted table page data comprise data organized in columns, the operations further comprising:
prior to the comparing, matching columns in the extracted web page data with columns of the spreadsheet data.

12. The computing system of claim 11, wherein the matching comprises placing the columns in the extracted table page data and the columns in the spreadsheet data in a common order.

13. The computing system of claim 1, wherein the spreadsheet data comprises data exported from the web page.

14. The computing system of claim 1, wherein the analyzing the code, the identifying a table identifier token, and the extracting table data are performed by an automation tool.

15. The computing system of claim 14, wherein the automation tool operates in a headless mode.

16. The computing system of claim 1, the operations further comprising:
from the identifier of the web page, or from the code of the web page, identifying a coding schema of the web page; and
selecting a table identifier token to be identified based at least in part on the coding schema.

17. The computing system of claim 1, wherein at least a portion of the extracted table data corresponds to data generated at least in part from data of a backend system accessed by the web page, and is not present in the data of the backend system.

18. A method, implemented in a computing system comprising at least one hardware processor and at least one memory coupled to the at least one hardware processor, the method comprising:
receiving an identifier of a spreadsheet file;
receiving an identifier of a web page comprising table data of a table, the web page comprising an identifier of the table;
analyzing code of the web page;
identifying a table identifier token for the table in the code of the web page based on the analyzing;
extracting table data for the table associated with the table identifier token from the code of the web page to provide extracted table data;
comparing the extracted table data with spreadsheet data of the spreadsheet file;
based on the comparing, identifying one or more differences between the extracted table data and the spreadsheet data to provide one or more identified differences; and
storing the one or more identified differences, wherein the one or more identified differences are displayed to a user on a user interface.

19. The method of claim 18, wherein the code of web page comprises source code of the web page or a document object model for the web page.

20. One or more computer-readable storage media comprising:
computer-executable instructions that, when executed by a computing system comprising at least one hardware processor and at least one memory coupled to the at least one hardware processor, cause the computing system to receive an identifier of a spreadsheet file;
computer-executable instructions that, when executed by the computing system, cause the computing system to receive an identifier of a web page comprising table data of a table, the web page comprising an identifier of the table;
computer-executable instructions that, when executed by the computing system, cause the computing system to analyze code of the web page;
computer-executable instructions that, when executed by the computing system, cause the computing system to identify a table identifier token for the table in the code of the web page based on the analyzing;
computer-executable instructions that, when executed by the computing system, cause the computing system to extract table data for the table associated with the table identifier token from the code of the web page to provide extracted table data;
computer-executable instructions that, when executed by the computing system, cause the computing system to compare the extracted table data with spreadsheet data of the spreadsheet file;
computer-executable instructions that, when executed by the computing system, cause the computing system to, based on the comparing, identify one or more differences between the extracted table data and the spreadsheet data to provide one or more identified differences; and
computer-executable instructions that, when executed by the computing system, cause the computing system to store the one or more identified differences, wherein the one or more identified differences are displayed to a user on a user interface.
